(19) United States
(12) Patent Application Publication
(10) Pub. No.: US 2012/0306372 A1
(43) Pub. Date: Dec. 6, 2012

(54) METHOD FOR DEMISTING A GLASS COVER AND DISPLAY MODULE THEREOF

(76) Inventor: Ching-Hung Yang, New Taipei City (TW)

(21) Appl. No.: 13/239,419

(22) Filed: Sep. 22, 2011

(30) Foreign Application Priority Data
Jun. 1, 2011 (TW) 100119187

(51) Int. Cl. H01J 7/24

(52) U.S. Cl. 315/117

(57) ABSTRACT

A method for demisting a glass cover is disclosed. The glass cover is disposed on a display panel. A heating unit is attached onto the glass cover. The method includes detecting a humidity value between the glass cover and the display panel by a humidity sensor and determining whether to start the heating unit to heat the glass cover according to the humidity value by a control circuit board.

### BACKGROUND OF THE INVENTION

1. Field of the Invention

The present invention relates to a demisting method and a display module thereof, and more specifically, to a method for demisting a glass cover covering a display panel and a display module thereof.

2. Description of the Prior Art

In general, a conventional digital signage display (DSD) device is mainly applied to image playback for a public place. When the digital signage display device is operated in an environment of a low temperature value (e.g. less than 15° C.) and a high humidity value (e.g. greater than 80%), a large amount of mist is generated in a gap between a glass cover and a display panel of the digital signage display device so as to make the digital signage display device incapable of displaying images clearly. In the prior art, a conventional method for demisting the digital signage display device is to utilize a fan installed inside the digital signage display device to make air convection therein, so that the demisting purpose can be achieved accordingly. However, this method not only needs additional space for disposal of the fan, but also makes an annoying noise when the fan is working to demist the digital signage display device. Furthermore, after the fan is used over a period of time, the problem that dust is accumulated on the fan occurs.

Another conventional demisting method is to utilize heat energy generated during operation of the digital signage display device to achieve the demisting purpose. However, since the digital signage display device needs to work over a period of time to generate sufficient heat energy for demisting, this method requires more time to demist the digital signage display device and is incapable of actively prevent the glass cover of the digital signage display device from fogging up.

### SUMMARY OF THE INVENTION

The present invention provides a method for demisting a glass cover disposed on a display panel. A heating unit is attached onto the glass cover. The method includes detecting a humidity value between the glass cover and the display panel by a humidity sensor and determining whether to power on the heating unit to heat the glass cover according to the humidity value by a control circuit board.

The present invention further provides a display module with a demisting function. The display module includes a display panel, a glass cover, a heating unit, a humidity sensor, and a control circuit board. The glass cover is disposed on the display panel. The heating unit is attached onto the glass cover. The humidity sensor is disposed between the heating unit and the display panel for detecting a humidity value between the glass cover and the display panel. The control circuit board is electrically connected to the humidity sensor and the heating unit for determining whether to power on the heating unit to heat the glass cover according to the humidity value detected by the humidity sensor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded diagram of a display module according to an embodiment of the present invention.

FIG. 2 is a flowchart of a method for utilizing a heating unit in FIG. 1 to demist a glass cover according to an embodiment of the present invention.

### DETAILED DESCRIPTION

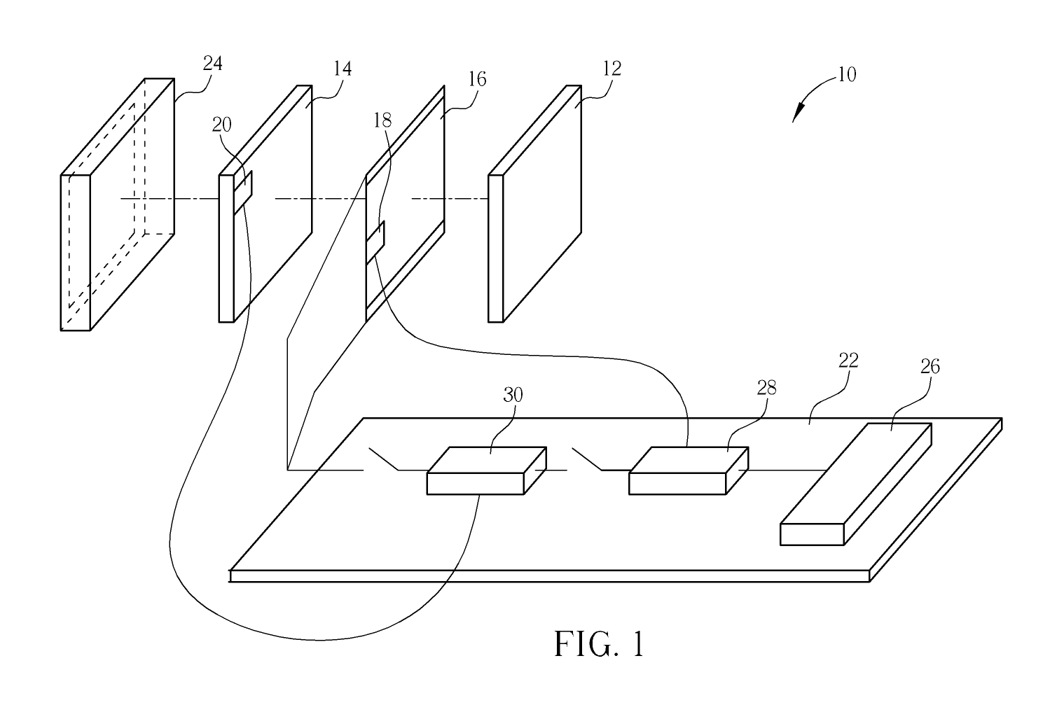

Please refer to FIG. 1, which is an exploded diagram of a display module 10 according to an embodiment of the present invention. As shown in FIG. 1, the display module 10 includes a display panel 12, a glass cover 14, a heating unit 16, a humidity sensor 18, a temperature sensor 20, a control circuit board 22, and an outer frame 24. In this embodiment, the display panel 12 is preferably a liquid crystal display (LCD) panel, but is not limited thereto. The glass cover 14 is disposed on the display panel 12 for protection of the display panel 12. The heating unit 16 is attached onto the glass cover 14. To be more specific, in this embodiment, the heating unit 16 is attached onto a surface of the glass cover 14 corresponding to the display panel 12 as a heating film by an electroplating process. The heating film is preferably a transparent semiconductor film, which generates heat energy by being electrified to excite electrons therein. The related description for the heating principle of the heating film is commonly seen in the prior art and therefore omitted herein.

The humidity sensor 18 is disposed between the heating unit 16 and the display panel 12. In this embodiment, the humidity sensor 18 is preferably disposed on the heating unit 16 (as shown in FIG. 1). The humidity sensor 18 is used for detecting a humidity value between the glass cover 14 and the display panel 12. The temperature sensor 20 is disposed on the glass cover 14. The temperature sensor 20 is used for detecting a temperature value of the glass cover 14. The control circuit board 22 is electrically connected to the heating unit 16, the humidity sensor 18, and the temperature sensor 20. As shown in FIG. 1, the control circuit board 22 has a power supply unit 26, a humidity control unit 28, and a temperature control unit 30. The power supply unit 26 is used for providing electric power to the heating unit 16. The humidity control unit 28 is used for determining whether to power on the heating unit 16 to heat the glass cover 14 according to the humidity value detected by the humidity sensor 18. The temperature control unit 30 is used for determining whether to power off the heating unit 16 according to the temperature value detected by the temperature sensor 20. The humidity control unit 28 and the temperature control unit 30 can be hardware, software, or firmware. The outer frame 24 is disposed on the glass cover 14. The outer frame 24 is a conventional casing of a display device and is used to contain the glass cover 14 and the display panel 12 for fixture and protection of the glass cover 14 and the display panel 12.

In practical application, for avoiding an electric shock accident caused by electron leakage of the heating unit 16 after being electrified, the display module 10 can further include an insulating film and an insulating tape (not shown in figures) so as to have an electric insulating function. The insulating film is used for attaching onto the heating unit 16. The insulating film is used for covering a gap between the glass cover 14 and the display panel 12. In brief, via the said insulating design, the present invention can prevent the display module 10 from electric leakage efficiently when the heating unit 16 heats the glass cover 14. Furthermore, the display module 10 can also adopt other insulating design, such as grounding the outer frame 24.

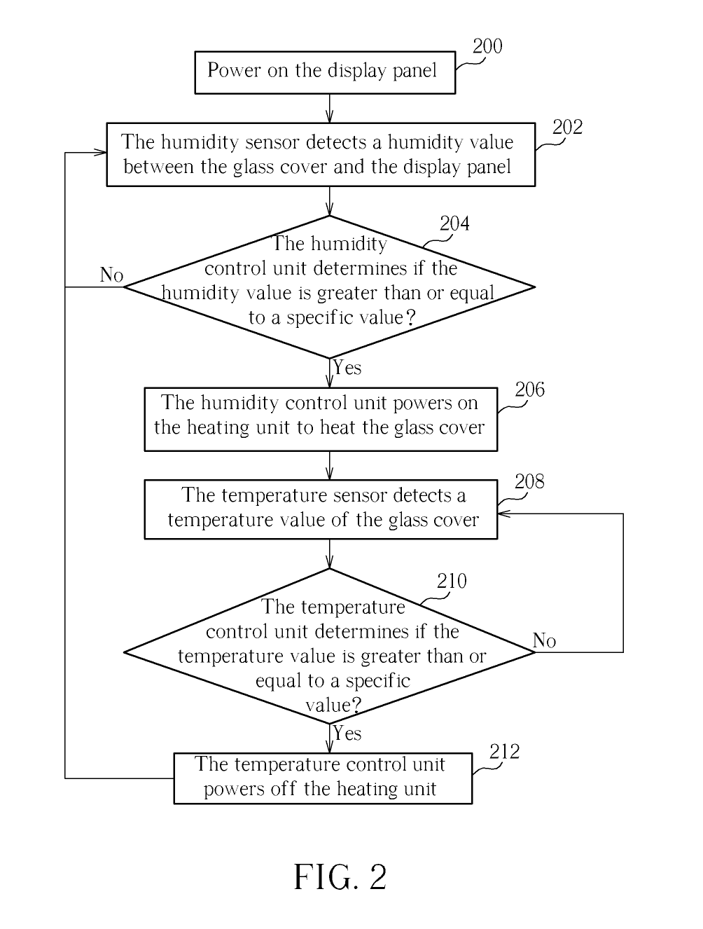

In the following, the demisting process of the display module 10 is described in detail . Please refer to FIG. 2, which is a flowchart of a method for utilizing the heating unit 16 in FIG. 1 to demist the glass cover 14 according to an embodiment of the present invention. The method includes the following steps.

Step 200: Power on the display panel 12.

Step 202: The humidity sensor 18 detects a humidity value between the glass cover 14 and the display panel 12.

Step 204: The humidity control unit 28 determines if the humidity value is greater than or equal to a specific value. If so, go to Step 206; if not, go to Step 202.

Step 206: The humidity control unit 28 controls the heating unit 16 to heat the glass cover 14.

Step 208: The temperature sensor 20 detects a temperature value of the glass cover 14.

Step 210: The temperature control unit 30 determines if the temperature value is greater than or equal to a specific value. If so, go to Step 212; if not, go to Step 208.

Step 212: The temperature control unit 30 powers off the heating unit 16.

More detailed description for the said steps is provided as follows. After the display panel 12 is powered on to display images (Step 200), the humidity sensor 18 detects a humidity value between the glass cover 14 and the display panel 12 (Step 202). After the humidity control unit 28 receives the humidity value detected by the humidity sensor 18, the humidity control unit 28 determines if the humidity value is greater than or equal to a specific value (Step 204). In this embodiment, the specific value is preferably 70%, but is not limited thereto. If the humidity control unit 28 determines the humidity value detected by the humidity sensor 18 is less than the specific value, the display module 10 performs Step 202, meaning that the display module 10 utilizes the humidity sensor 18 to keep monitoring the humidity value between the glass cover 14 and the display panel 12.

On the other hand, if the humidity control unit 28 determines the humidity value detected by the humidity sensor 18 is grater than or equal to the specific value, it means that the display module 10 is operated in an environment of a high humidity value. At this time, for preventing the glass cover 14 from fogging up, the humidity control unit 28 powers on the heating unit 16 to heat the glass cover 14 (Step 206). Accordingly, via increasing the temperature of the glass cover 14 by the heating film of the heating unit 16, the purpose of reducing the humidity value of the glass cover 14 and the display panel 12 is achieved so as to demist the glass cover 14. To be noted, the humidity control unit 28 utilizes a simple circuit on/off design (as shown in FIG. 1) to control powering on/off of the heating unit 16. As for the related control design, it is commonly seen in the prior art.

In brief, when the humidity control unit 28 determines the humidity value is less than the specific value, the circuit between the humidity control unit 28 and the heating unit 16 is open. At this time, the circuit between the temperature control unit 30 and the heating unit 16 is close, and the circuit between the humidity control unit 28 and the temperature control unit 30 is open. Instead, when the humidity control unit 28 determines the humidity value is greater than or equal to the specific value, the circuit between the humidity control unit 28 and the heating unit 16 is switched to a closed circuit state. At this time, the circuit between the temperature control unit 30 and the heating unit 16 is close, and the circuit between the humidity control unit 28 and the temperature control unit 30 is close. Accordingly, electric power provided by the power supply unit 26 can be transmitted to the heating unit 16 for powering on the heating unit 16.

During the process of heating the glass cover 14, for avoiding overheating the glass cover 14, the display module 10 utilizes the temperature sensor 20 to detect a temperature value of the glass cover 14 (Step 208). After the temperature control unit 30 receives the temperature value, the temperature control unit 30 determines if the temperature value is greater than or equal to a specific value (Step 210). In this embodiment, the specific value is preferably 45° C., but is not limited thereto. If the temperature control unit 30 determines the temperature value is less than the specific value, the display module 10 performs Step 208, meaning that the display module 10 utilizes the temperature sensor 20 to keep monitoring the temperature value of the glass cover 14.

On the other hand, if the temperature control unit 30 determines the temperature value is greater than or equal to the specific value, it means that the temperature value of the glass cover 14 is excessively high. At this time, for avoiding a burn injury accident, the temperature control unit 30 powers off the heating unit 16 (Step 212) to stop heating the glass cover 14, so that the glass cover 14 can be cooled down. Similarly, the temperature control unit 30 also utilizes the circuit on/off design as shown in FIG. 1 to control powering on/off of the heating unit 16. In brief, when the temperature control unit 30 determines the temperature value is less than the specific value, both of the circuit between the temperature control unit 30 and the heating unit 16 and the circuit between the humidity control unit 28 and the temperature control unit 30 remain in a closed circuit state, so that the heating unit 16 can keep heating the glass cover 14.

Instead, when the temperature control unit 30 determines the temperature value is greater than or equal to the specific value, the circuit between the temperature control unit 30 and the heating unit 16 is switched to an open circuit state, so as to cut off power transmission between the power supply unit 26 and the heating unit 16. Accordingly, the heating unit 16 stops heating the glass cover 14 so as to achieve the purpose of cooling down the glass cover 14. Furthermore, as shown in FIG. 2, after the temperature control unit 30 powers off the heating unit 16, the display module 10 performs Step 202 again and then performs the said steps repeatedly. In such a manner, the display module 10 can keep monitoring the humidity value between the glass cover 14 and the display panel 12, so as to improve the image playback quality of the display panel 12.

It should be mentioned that the temperature detecting steps (i.e. Steps 208-212) are omissible steps. That is to say, the display module 10 can only have a humidity detection function without the temperature sensor 20 and the temperature control unit 30, so as to simplify the structural design and the detecting process of the display module 10. Furthermore, in practical application, the situation may occur that the humidity value between the glass cover 14 and the display panel 12 is excessively high (e.g. greater than or equal to 90%). For example, when the display module 10 is powered on at the first time after leaving the factory, the humidity value between the glass cover 14 and the display panel 12 may be greater than 90%. In this situation, the display module 10 can directly control the heating unit 16 to heat the glass cover 14 without performing Steps 208-212. In such a manner, the demisting efficiency of the display module 10 can be further improved by heating the glass cover 14 continuously, so as to demist the glass cover 14 quickly when the display module 10 is operated in an environment with an excessively-high humidity value.

Furthermore, Step 202 is also an omissible step for further simplifying the detecting process of the display module 10. That is to say, the display module 10 can keep monitoring the humidity value between the glass cover 14 and the display panel 12 and the temperature value of the glass cover 14 even if the display panel 12 is in a power-off state.

Besides, disposal of the heating unit 16 and the glass cover 14 is not limited to the said embodiment. For example, the heating unit 16 can be a resistance-wire form instead, meaning that the heating unit 16 can further includes at leas one resistance wire to attach onto a surface of the glass cover 14 corresponding to display panel 12 . In another embodiment, the heating unit 16 can be a resistance-pad form, meaning that the heating unit 16 can include at least one resistance pad to attach onto at least one side of the glass cover 14. As for which design is utilized, it depends on the practical application of the display module 10.

Compared with the prior art, the present invention utilizes the design, in which the heating unit is attached onto the glass cover and the humidity sensor is disposed between the glass cover and the display panel, to perform a demisting process by heating the glass cover when the humidity sensor detects the humidity value between the glass cover and the display panel is greater than or equal to a specific value. In such a manner, via the said design, the present invention not only improves the demisting efficiency of the display module so as to increase the image playback quality of the display module in an environment of a high humidity value, but also solve the said noise problem and the said dust accumulating problem.

Those skilled in the art will readily observe that numerous modifications and alterations of the device and method may be made while retaining the teachings of the invention.

What is claimed is:

1. A method for demisting a glass cover disposed on a display panel, a heating unit being attached onto the glass cover, the method comprising:
detecting a humidity value between the glass cover and the display panel by a humidity sensor; and
determining whether to power on the heating unit to heat the glass cover according to the humidity value by a control circuit board.

2. The method of claim 1, wherein when the humidity value is greater than or equal to a specific value, the control circuit board powers on the heating unit.

3. The method of claim 2 further comprising:
detecting a temperature value of the glass cover by a temperature sensor; and
determining whether to power off the heating unit by the control circuit board.

4. The method of claim 3, wherein when the temperature value is greater than or equal to a specific value, the control circuit board powers off the heating unit.

5. A display module with a demisting function, the display module comprising:
a display panel;
a glass cover disposed on the display panel;
a heating unit attached onto the glass cover;
a humidity sensor disposed between the heating unit and the display panel, for detecting a humidity value between the glass cover and the display panel; and
a control circuit board electrically connected to the humidity sensor and the heating unit, for determining whether to power on the heating unit to heat the glass cover according to the humidity value detected by the humidity sensor.

6. The display module of claim 5, wherein the control circuit board has a humidity control unit for powering on the heating unit when the humidity value is greater than or equal to a specific value.

7. The display module of claim 6 further comprising:
a temperature sensor disposed on the glass cover for detecting a temperature value of the glass cover;
wherein the control circuit board is used for determining whether to powering off the heating unit according to the temperature value detected by the temperature sensor.

8. The display module of claim 7, wherein the control circuit board further has a temperature control unit, and the temperature control unit is used for powering off the heating unit when the temperature value is greater than or equal to a specific value.

9. The display module of claim 5, wherein the heating unit comprises a heating film formed on a surface of the glass cover corresponding to the display panel by an electroplating process.

10. The display module of claim 9 further comprising:
an insulating film attached to the heating unit.

11. The display module of claim 10 further comprising:
an insulating tape covering a gap between the glass cover and the display panel.

12. The display module of claim 5, wherein the heating unit comprises at least one resistance wire attached to a surface of the glass cover corresponding to the display panel.

13. The display module of claim 5, wherein the heating unit comprises at least one resistance pad attached to at least one side of the glass cover.

14. The display module of claim 5, wherein the control circuit board has a power supply unit for providing electric power to the heating unit.

15. The display module of claim 5 further comprising:
an outer frame disposed on the glass cover for containing the glass cover and the display panel.
